(19) United States
(12) Patent Application Publication
(10) Pub. No.: US 2006/0133395 A1
(43) Pub. Date: Jun. 22, 2006

(54) Pretreatment device for a unitized detergent dose

(76) Inventors: Debra Park, Mesa, AZ (US); Daniel Wood, Phoenix, AZ (US); Rosanne Benavides, Phoenix, AZ (US); Aurora Stamper, Phoenix, AZ (US)

Correspondence Address: SNELL & WILMER, LLP, ONE ARIZONA CENTER, 400 E. VAN BUREN, PHOENIZ, AZ, 85004-2202, US

(21) Appl. No.: 11/014,579

(22) Filed: Dec. 16, 2004

(51) Int. Cl. H04L 12/56; H04L 12/28

(52) U.S. Cl. 370/412

(57) ABSTRACT

The present invention discloses a device consisting of an implement configured with a piercing mechanism that allows the user to make a uniform opening in the package through which the fluid inside can dispense. In one embodiment, the implement is configured with an affixing mechanism for affixing the implement to a surface. In another exemplary embodiment of the present invention, the implement is configured to pierce and house the packet during pretreatment.

### FIELD OF INVENTION

This invention relates generally to pretreatment devices, and more particularly, to pretreatment devices for a unitized detergent dose.

### BACKGROUND OF THE INVENTION

Since the inception of liquid laundry detergents, one of the primary functions has been for the consumer to presaturate or “pre-treat” a stained or soiled garment with a portion of the detergent. With the introduction of new product delivery methods, such as packaged doses (e.g., polyvinyl alcohol (PVA) packets containing discreet doses of liquid detergent), consumers have lost the ability to easily pretreat their stained or soiled garments. For example, generally, the user of these products must use a knife, razor, scissors or other slicing or piercing object to sever the pretreatment package to pretreat their items. Further, users of these packets must have a severing apparatus on hand, which may leave a mess as the product runs out of the package due to uneven holes, gouge portions of the package, etc.

### SUMMARY OF THE INVENTION

Briefly, the present invention is directed towards an implement that assists a user with removing, preferably, a pre-determined amount of a liquid (e.g., detergent) from a packaged dose. For example, in one exemplary embodiment, the implement makes a uniform opening in the package through which the fluid inside can flow out. In one embodiment, the implement is configured with an affixing mechanism for affixing the implement to a surface. In another exemplary embodiment of the present invention, the implement is configured to puncture and house the packet during pretreatment. In accordance with another aspect of the present invention, a method for pretreatment using a pretreatment implement is provided.

### BRIEF DESCRIPTION OF THE DRAWINGS

Additional aspects of the present invention should become evident upon reviewing the non-limiting embodiments described in the specification taken in conjunction with the accompanying figures, wherein like numerals designate like elements, and:

FIG. 1 is a top perspective view of an exemplary pretreatment implement in accordance with the present invention;

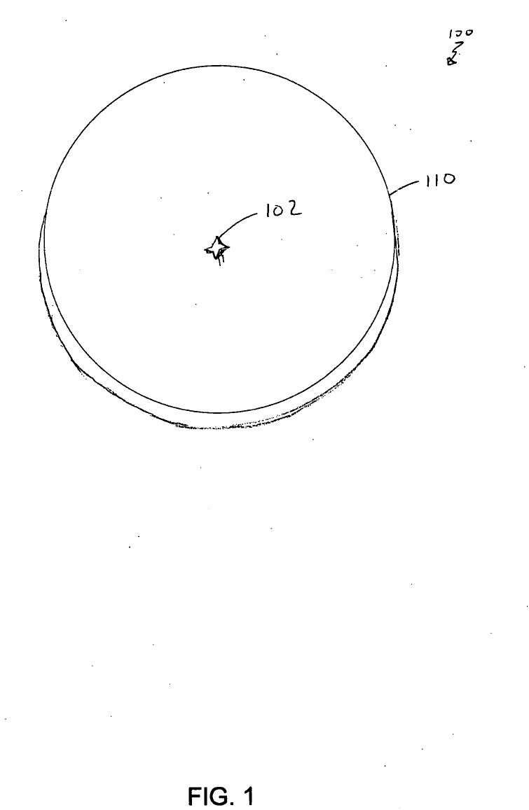

FIGS. 2A and 2B are diagrams of exemplary pretreatment implements in accordance with the present invention;

FIG. 3 is an illustration of an exemplary affixing mechanism in accordance with the present invention;

FIG. 4 is an illustration of an exemplary pretreatment kit in accordance with the present invention;

FIG. 5 depicts another exemplary pretreatment implement in accordance with the present invention; and

FIG. 6 illustrates an exemplary method for pretreatment in accordance with the present invention.

### DETAILED DESCRIPTION

The following descriptions are of exemplary embodiments of the invention only, and are not intended to limit the scope, applicability or configuration of the invention in anyway. Rather, the following description is intended to provide convenient illustration for implementing various embodiments of the invention. As will become apparent, various changes may be made in the function and arrangement of the elements described herein without departing from the spirit and scope of the invention. For example, though not specifically described, many shapes and orientations of the pretreatment device should be understood to fall within the scope of the present invention. Similarly, though generally described herein with respect to laundry detergent, as noted below, numerous other liquids may be used, and the present invention should not necessarily be limited to laundry detergent alone. Further still, the present invention is particularly suited to PVA packets; though it should be appreciated that it may likewise find use with other water-soluble, dissolvable and/or non-dissolvable packaged doses such that the packaged doses may be puncturable.

As used herein, the term packet refers to any enclosed and/or partially enclosed packet, straw, pouch, satchel, bag, bottle, and/or the like. Packets may be comprised of any water-soluble and/or dissolvable material in the form of a film configured to substantially dissolve in response to contact with water. For example, in one embodiment, packets may be comprised of polyvinyl alcohol (PVA). Various liquids and/or cleaning agents may be enclosed in the packets, such as, for example water, floor cleaners, laundry detergents, dish detergents, dishwasher detergents, spot free rinses, presoaks, delimers, glass cleaners, surface cleaners, all-purpose cleaners, deodorizers, toilet bowl cleaners, bathroom cleaners, carpet cleaners, bubble baths, aromatherapy washes, soaps, bleaches, shampoos, conditioners, and/or the like.

In general, the present invention comprises an implement 100 for pretreatment that assists in removing a liquid from a packaged dose, for example, in the context of a PVA packet. For example, in one embodiment, implement 100 may be configured with a piercing mechanism 102 such as one or more puncture points protruding from the body of implement 100. Implement 110 may also be configured with a base 110. In the present exemplary embodiment, the body of implement 100 is configured to be base 110, however, the body of implement 100 and base 110 may be configured to be separate components. In the present exemplary embodiment, implement 100 is preferably comprised of a substantially rigid plastic such as high-density polyethylene (“HDPE”), but any other suitable material rigid, semi-rigid or even flexible material may be used.

In various embodiments, piercing mechanism 102 is configured to facilitate making a consistently sized opening of a packet to facilitate orderly pretreatment. Piercing mechanism 102 may comprise a blade, a point, a screw, sandpaper, pins, sharp nubs, scissors and/or any other type of cutting, piercing, and/or puncturing apparatus. As used herein, a generally consistently sized opening refers to a uniform, orderly, homogeneous, controlled and/or even opening of a packet. “Orderly pretreatment” refers to a generally clean, neat, non-dripping, and/or non-messy removal of a liquid from a packet when the packet is squeezed, pressed, and/or compressed.

In various embodiments, piercing mechanism 102 may be configured to be static and/or moveable. For example, piercing mechanism 102 may be spring loaded, slideable, compressible, fixed, stationary and/or configured in any other static and/or moveable configuration. Piercing mechanism 102 may also be configured with one or more safety guards for preventing injury to a user and/or a surface. For example, piercing mechanism 102 may be configured with a piece of soft plastic or cardboard configured as a blade guard to prevent accidental puncturing of persons and/or other materials.

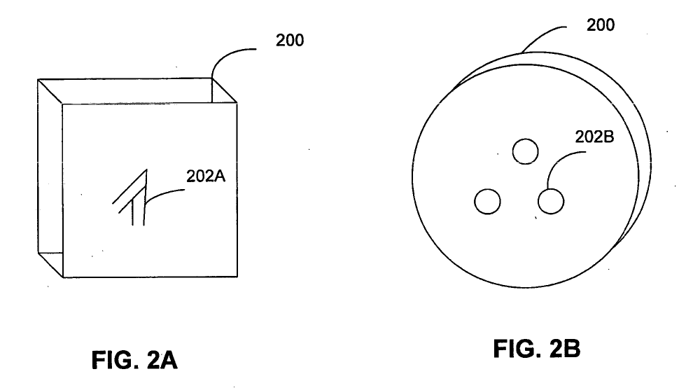

In an exemplary embodiment, depicted in FIG. 2A, piercing mechanism 102 may comprise a blade 202A configured in a predetermined length and width. For example, blade 202A may comprise an entire razor blade length (i.e. approximately two inches) or any part thereof. Blade 202A may be configured with a remote switch to facilitate sliding blade 202A over a packet. Blade 202A may also be configured to be spring loaded to facilitate safety and/or to facilitate vertical, horizontal and/or other multi-directional movement of blade 202A.

In another exemplary embodiment, illustrated in FIG. 2B, piercing mechanism 102 may comprise one or more puncturing pins 202B. Pins 202B maybe configured in any shape and/or size to facilitate puncturing of a packet in a substantially uniform manner. For example, in one embodiment, pins 202B comprise three pins configured in a triangular pattern. Pins 202B may be configured in any size and/or shape. For example, pins 202B may be configured as three ½ mm diameter pins. That said, it should be appreciated that while three pins are illustrated in FIG. 2B, various other numbers and configurations of pins 202B may be used and still fall within the scope of the present invention.

As mentioned above, in accordance with various embodiments of the present invention, implement 100 preferably has an aesthetically pleasing, sleek design. For example, in the various embodiments described herein, implement 100 may be substantially circular in form. That is, the corners of the device housing, as well as the edges, tend to be of a rounded nature. Alternatively, implement 100 may be substantially angular in form. Similarly, piercing mechanism 102 may have symmetrical features with respect to implement 100. That is, symmetry of the various features and views of implement 100 may be present. Still further, for aesthetic reasons, implement 100 (and likewise various other components of implement 100) may optionally be of varying colors.

In accordance with another aspect of implement 100, an affixing mechanism may be provided to secure base 110 to a surface. For example, various means for affixing base 110 to a surface include snaps, adhesives, Velcro, tapes, glues, strong magnets, glue strips, ceramics, plastics, threadable connections and/or the like, now known or as yet unknown. Base 110 may be configured to be affixed to any surface, such surfaces being, for example, washing machines, detergent boxes, countertops, vacuum cleaners, walls, cabinets, tiles and/or the like.

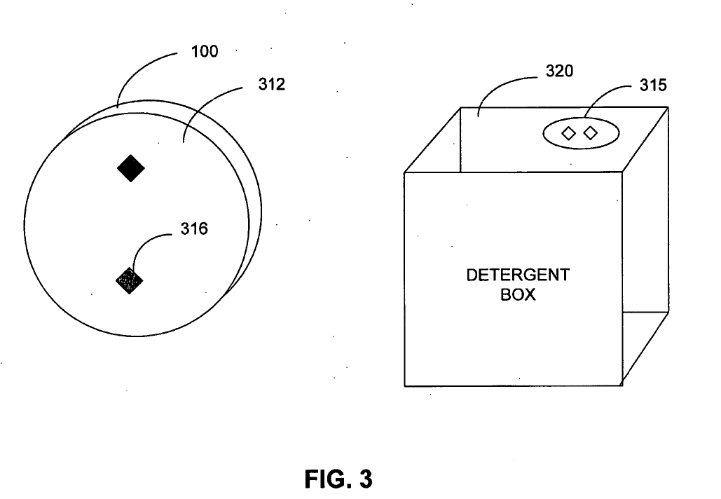

In the presently described embodiment, exemplified in FIG. 3, the back face 312 of base 110 may be configured with one or more affixing mechanisms for facilitating affixation of implement 100 to one or more surfaces. For example, in one embodiment, back face 312 comprises a reception 315 and corresponding teeth 316 that affixes to surface 320. Surface 320 may be any surface described herein, such as, for example, the top of a detergent box. In the present embodiment, teeth 316 are located on back face 312 and reception 315 is located on surface 320, though it should be apparent that the locations may be reversed. Teeth 316 preferably engage reception 315 in a snap fit manner to secure implement 100 and base 110. Preferably, base 110 may be configured with a disengagement mechanism for facilitating disengagement of implement 100 from surface 320. In the present embodiment, to disengage implement 100, implement 100 may be lifted, pulled, twisted, slid, and/or moved in any similar manner to facilitate disengagement from reception 315. That said, it should be appreciated that while an affixing mechanism comprising a reception and corresponding teeth is illustrated in FIG. 3, various other affixing mechanisms and configurations may be used and still fall within the scope of the present invention

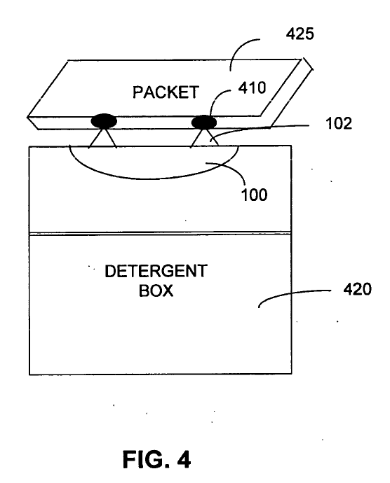

In accordance with an alternative embodiment of the present invention, and with reference to FIG. 4, a pretreatment kit 400 is provided. In this embodiment, pretreatment kit 400 comprises implement 100 coupled with a packet 410 or otherwise connected to each other, packaged and/or adjacent to one another. For example, packets 410 may be contained in a box 420 and/or other packaging, and box 420 may be equipped with implement 100. That is, box 420 may contain an attached implement 100 and/or a free-standing implement 100 configured to be capable of standing apart from, unattached to and/or supported by anything.

Kit 400 may be configured such that implement 100 is used to pierce packet 410 to create a hole or holes 425 in a convenient, uniform, and/or orderly way. That is, in accordance with the present embodiment, piercing mechanism 102 suitably pierces packet 410 so that the liquid enclosed within packet 410 may be dispensed from packet 410 for pretreatment. Holes 425 suitably allows the liquid to be dispensed and/or likewise allow the liquid to flow outside of packet 410.

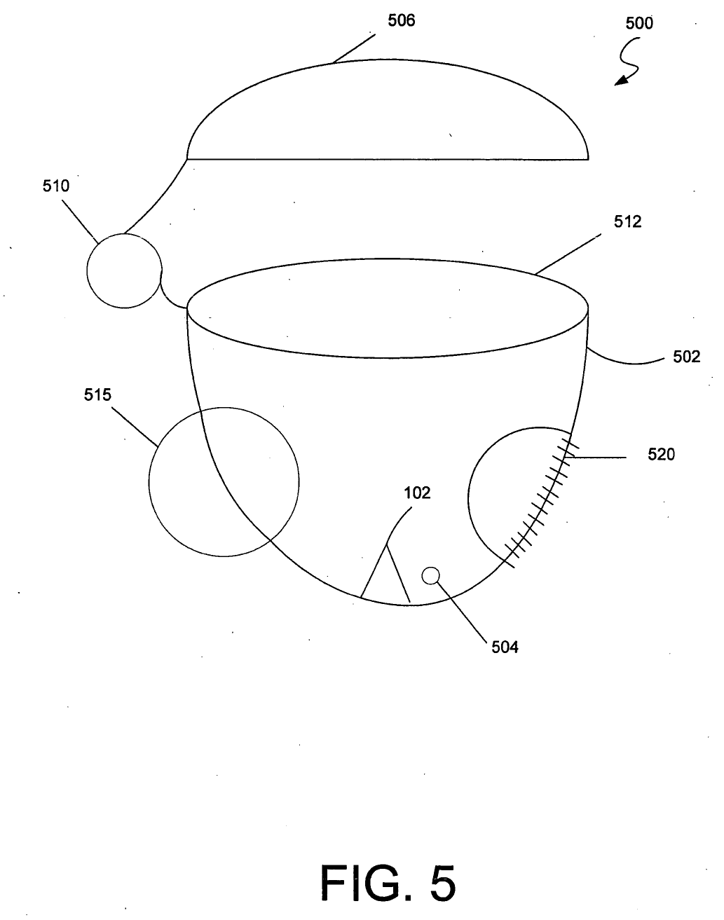

In yet another exemplary embodiment of the present invention, implement 100 is configured with additional features for facilitating pretreatment. For example, with reference to an exemplary embodiment depicted in FIG. 5, implement 500 is configured with a receiving area or bowl 502 for holding a packet. Piercing mechanism 102 is configured inside bowl 502 to facilitate cleanliness and ease in puncturing. That is, a packet is placed in the opening 512 of bowl 502 and punctured by piercing mechanism 102.

Implement 500 may also be configured with a lid 506. For example, lid 506 may comprise rigid plastic such as high-density polyethylene (“HDPE”), and/or any other suitable material rigid, semi-rigid and/or flexible material.

In various embodiments, lid 506 may be used to prevent leakage and/or messes during pretreatment. Lid 506 may also be configured to be rotatably connected to a receiving area or bowl 502. For example, lid 506 may be rotatably connected to bowl 502 by a hinge 510 configured to open and/or close with substantial ease. While a hinge is described herein, lid 506 may be rotatably connected to bowl 502 using any rotatable connecting device, such as, for example, a plastic seam, rubber, a ball-and-socket, a spring, an axle or the like. Hinge 510 may be configured to open and/or close upon activation. That is, in such embodiments, hinge 510 is configured to close and/or shut and/or to open and/or release before, during and/or after pretreatment.

For example, in one embodiment, hinge 510 may be configured to open during a wash cycle of a laundry machine to release the detergent. For example, hinge 510 may be configured to open after a discreet period of time, such as when implement 100 is turned upon lid 506, when implement 100 when subjected to a predetermined amount of movement and/or various other times.

In another embodiment, piercing mechanism 102 may be configured to extend only when hinge 510 is closed in order to facilitate safety while implement 100 is not being used to pierce a packet. For example, piercing mechanism 102 may be configured as a blade connected to hinge 510. When hinge 510 is in the “closed” position, blade 102 may be configured to extend for puncturing and when hinge 510 is in the “open” position, blade 102 is configured to retract for safety.

In another exemplary embodiment of the present invention, implement 500 is configured with one or more holes 504 to facilitate the dispensing of a liquid inside implement 500. That is, after a packet is pierced, the liquid inside the packet may seep and/or discharge in a uniform manner through holes 504. Additionally, in accordance with another aspect of the present invention, holes 504 are configured to allow water to enter implement 500 to facilitate dissolving of the detergent inside a packet before and/or during washing and/or pretreatment.

In yet another embodiment, holes 504 are configured adjacent to puncture point 102 and/or at any other location within implement 500 to facilitate dispensing liquid and/or water entry at a certain location. For example, in one embodiment, holes 504 are configured adjacent to a pretreatment device 520 to facilitate pretreatment of a material and/or surface. In accordance with various embodiments of the present invention, pretreatment device 520 may comprise a brush, a scrubber, bristles, a washboard, a sponge, a mop, a swab, sandpaper and/or any other scouring type of material. Holes 504 configured adjacent to pretreatment device 520 may facilitate delivery of a liquid, soap and/or other cleaner to a surface for pretreatment with pretreatment device 520.

In addition to and/or in an alternative embodiment, implement 500 may comprise a grip 515 configured to facilitate holding implement 500 during pretreatment. Grip 515 may comprise a roller ball, a rubber and/or other frictional surface to facilitate gripping, one or more knobs, one or more grooves, and/or any other gripping configuration and/or device.

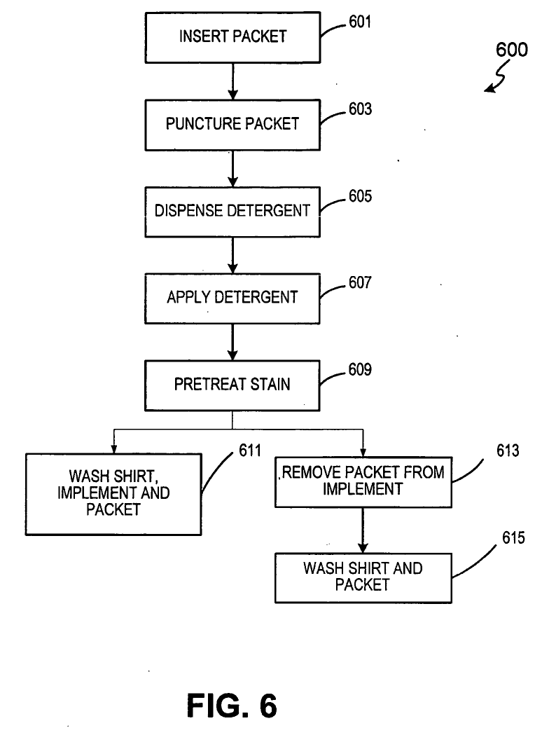

For example, with reference to an exemplary method for pretreating a stain on a shirt illustrated in FIG. 6, a laundry detergent packet is inserted into implement 100, 500 (step 601) and punctured by puncturing points 502 (step 603). By inserting a packet, a packet is placed into a receiving area of implement 100, 500. That is, a packet may be coupled to the puncture points of implement 100, placed within bowl 502 of implement 500 and/or a packet may be coupled with implement 100, 500 consistent with any method described herein. Puncture points 502 may be configured as any puncture points described herein.

Upon puncture of the packet, the detergent inside the packet seeps and/or dispenses from the packet (step 605). After dispensing from the packet, the detergent dispenses through holes 504 and emits from implement 500. If implement 500 is not configured with holes 504, then detergent may dispense from opening 512 and/or from the detergent packet itself. The detergent may dispense through holes 504 and/or any other opening instantaneously and/or it may emit at a discreet time. After the detergent dispenses from the packet, it may be applied to the shirt (step 607). The detergent may be applied to the shirt automatically, by for example, dripping onto the shirt and/or the detergent may be applied by a user placing the detergent onto the shirt by way of rubbing implement 500 onto the shirt and/or the like.

Pretreatment device 520 may be used to scrub the stain (step 609) for pretreatment of the stain before the shirt is washed. If implement 500 is not equipped with pretreatment device 520, then the user may use any other pretreatment device and/or process for pretreatment. Such alternate pretreatment devices and/or processes may include, for example, scrubbing by hand, use of a sponge, use of the fabric itself, use of a washboard, soaking the fabric, and/or letting the detergent work on the fabric without any further treatment. After the shirt has been pretreated, the shirt may be placed in the washing machine (step 611) along with implement 500 and the packet for further washing. Alternatively, after pretreatment the packet may be removed from implement 500 (step 613) so that just the packet and shirt are placed in the washing machine for washing (step 615). Washing can occur at any time following pretreatment. For example, implement 500 may be used to pretreat a stain on one day for washing on a subsequent day. While FIG. 6 illustrates an exemplary method for pretreatment in accordance with the present invention, pretreatment may occur through any of the preceding steps and/or any portion of the preceding steps in any order. Further, additional steps may be used for pretreatment.

Lastly, various aspects of the invention have been described in illustrative embodiments. Of course, many combinations and modifications of the above-described structures, arrangements, proportions, elements, materials and components, used in the practice of the invention, in addition to those not specifically described, may be varied and particularly adapted to specific environments and operating requirements without departing from those principles.

1. An implement for facilitating pretreatment using dissolvable packets, comprising:
a body with a receiving area; and
a piercing mechanism configured to puncture a packaged dose with a substantially consistently sized hole.

2. The implement for facilitating pretreatment in accordance with claim 1, wherein said piercing mechanism comprises at least one of a blade, a point, a corkscrew, sandpaper, pins, sharp nubs, and scissors.

3. The implement for facilitating pretreatment in accordance with claim 1, further comprising a base configured with an affixing mechanism to facilitate affixation of said implement to a surface.

4. The implement for facilitating pretreatment in accordance with claim 3, wherein said affixing mechanism comprises at least one of a snap, an adhesive, Velcro, tape, glue, a strong magnet, a glue strip, a ceramic, a plastic, a threadable connection, and a reception with corresponding teeth.

5. The implement for facilitating pretreatment of claim 1, wherein said packaged dose comprises at least one of water, floor cleaner, laundry detergent, dish detergent, dishwasher detergent, spot free rinse, presoak, delimer, glass cleaner, surface cleaner, all-purpose cleaner, deodorizer, toilet bowl cleaner, bathroom cleaner, carpet cleaner, bubble bath, aromatherapy wash, soap, shampoo, conditioner, and bleach.

6. An implement for facilitating pretreatment using a packaged dose, comprising:
a receiving area for receiving the packaged dose;
at least one piercing mechanism configured to facilitate piercing said packaged dose; and
a lid rotatably connected to said receiving area.

7. The implement for facilitating pretreatment of claim 6, wherein said lid is configured to open upon activation.

8. The implement for facilitating pretreatment of claim 6, further comprising a grip.

9. The implement for facilitating pretreatment of claim 6, further comprising a pretreatment device.

10. The implement for facilitating pretreatment of claim 9, wherein said pretreatment device comprises at least one of a brush, a scrubber, bristles, a washboard, a sponge, a mop, a swab, and sandpaper.

11. The implement for facilitating pretreatment of claim 6, wherein said implement further comprises a base.

12. The implement for facilitating pretreatment in accordance with claim 11, wherein said base is configured with an affixing mechanism to facilitate affixation of said implement to a surface.

13. The implement for facilitating pretreatment in accordance with claim 12, wherein said affixing mechanism comprises at least one of a snap, an adhesive, Velcro, tape, glue, a strong magnet, a glue strip, a ceramic, a plastic, a threadable connection, and a reception with corresponding teeth.

14. The implement for facilitating pretreatment of claim 6, wherein said implement is configured with at least one hole.

15. The implement for facilitating pretreatment of claim 6, wherein said packaged dose comprises at least one of water, floor cleaner, laundry detergent, dish detergent, dishwasher detergent, spot free rinse, presoak, delimer, glass cleaner, surface cleaner, all-purpose cleaner, deodorizer, toilet bowl cleaner, bathroom cleaner, carpet cleaner, bubble bath, aromatherapy wash, soap, shampoo, conditioner, and bleach.

16. A pretreatment and cleaning kit comprising:
at least one sealed packet containing a cleaning agent;
an implement having a piercing mechanism configured to pierce said packet to facilitate dispensing a metered dose of said cleaning agent from said packet, wherein said piercing mechanism is further configured to retain said packet for use during at least one of pretreatment and cleaning.

17. The pretreatment and cleaning kit of claim 16, wherein said cleaning agent comprises at least one of water, floor cleaner, laundry detergent, dish detergent, dishwasher detergent, spot free rinse, presoak, delimer, glass cleaner, surface cleaner, all-purpose cleaner, deodorizer, toilet bowl cleaner, bathroom cleaner, carpet cleaner, bubble bath, aromatherapy wash, soap, shampoo, conditioner, and bleach.

18. A pretreatment and cleaning kit comprising:
at least one sealed packet containing a cleaning agent;
an implement having a piercing mechanism configured to pierce said packet to facilitate dispensing a metered dose of said cleaning agent from said packet; and
a pretreatment device.

19. The pretreatment and cleaning kit of claim 18, wherein said pretreatment device comprises at least one of a brush, a scrubber, bristles, a washboard, a sponge, a mop, a swab, and sandpaper.
